(19) United States
(12) Patent Application Publication
(10) Pub. No.: US 2009/0222636 A1
(43) Pub. Date: Sep. 3, 2009

(54) MEMORY SYSTEM AND MEMORY INITIALIZING METHOD

(75) Inventors: Junji YANO, Kanagawa (JP); Hidenori Matsuzaki, Tokyo (JP); Kosuke Hatsuda, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 12/394,870

(22) Filed: Feb. 27, 2009

(30) Foreign Application Priority Data
Feb. 29, 2008 (JP) 2008-051385

(51) Int. Cl. G06F 12/02; G06F 15/177

(52) U.S. Cl. 711/166; 713/2; 711/E12.002

(57) ABSTRACT

A memory system includes a controller that writes internal information concerning an operation state of the memory system in a special LBA area allocated to a predetermined logical address range in a second storing memory and writes the internal information in a first storing memory, and reads out, when the memory system is started up, the internal information to manage the operation state. The controller stores the internal information written in the first storing memory in the second storing memory as a snapshot when a predetermined condition is satisfied and, when an error occurs and the internal information written in the special LBA area cannot be read out when the memory system is started up, captures the internal information stored as the snapshot into the first storing memory and reads out the internal information.

### CROSS-REFERENCE TO RELATED APPLICATIONS

This application is based upon and claims the benefit of priority from the prior Japanese Patent Application No. 2008-051385, filed on Feb. 29, 2008; the entire contents of which are incorporated herein by reference.

### BACKGROUND OF THE INVENTION

1. Field of the Invention

The present invention relates to a memory system including a nonvolatile semiconductor storage device and a memory initializing method.

2. Description of the Related Art

Some personal computers (PC) employ a hard disk device as a secondary storage device. In such PCs, a technology is known for backing up data that has been stored in the hard disk device to prevent the data from becoming invalid because of some failure. For example, when act of changing data in the hard disk device is detected, a snapshot as a backup copy of the data before the change is taken and a log of changes made to the data is generated. Then, processing for taking a new snapshot, invalidating a log taken in the past before the new snapshot was taken, and generating a new log is repeated at every predetermined time (see, for example, US Patent Application Publication No. 2006/0224636). In case data becomes invalid due to some reason, the data can be restored by referring to the snapshot and the log. In recent years, a capacity of a NAND flash memory as a nonvolatile semiconductor storage device has been increased dramatically. As a result, PCs including a memory system having the NAND flash memory as a secondary storage device have been put to practical use. In such a personal computer, the NAND flash memory has an area accessible according to commands (a Read command, a Write command, etc.) from a host apparatus and a special area not accessible according to normal commands issued from the host apparatus (an area accessible according to command issued from a module configuring firmware expanded in the memory system).

Of the areas in the NAND flash memory, important information such as a history of warning events is stored in the special area. For example, when the memory system is turned on, as initialization processing for the memory system, the information in the special area is read out and information concerning a state of the memory system (management information) at the time when the memory system is turned off is restored on the memory system.

However, when the initialization processing for the memory system is performed, if data stored in the special area cannot be read out because of some error, the management information at the time when the memory system is turned off cannot be restored on the memory system. Therefore, reliability of restoration processing for the management information is low.

### BRIEF SUMMARY OF THE INVENTION

According to an aspect of the present invention, there is provided a memory system comprises a first storing area included in a volatile semiconductor memory from which data is read out and to which data is written; a second storing area included in a nonvolatile semiconductor memory from which data is read out and to which data is written; and a controller that performs data transfer between a host apparatus and the second storing area via the first storing area, writes internal information concerning an operation state of the memory system in a special LBA area allocated to a predetermined logical address range in the second storing area and writes the internal information in the first storing area, and reads out, when the memory system is started up, the internal information written in the special LBA area to manage the operation state, wherein the controller stores the internal information written in the first storing area in the second storing area as a snapshot when a predetermined condition is satisfied, captures, when the memory system is started up, the internal information stored in the second storing area as the snapshot into the first storing area, and reads out the internal information captured into the first storing area when an error occurs and the internal information written in the special LBA area cannot be read out when the memory system is started up.

According to another aspect of the present invention, there is provided a memory system comprising a first storing area included in a volatile semiconductor memory from which data is read out and to which data is written; a second storing area included in a nonvolatile semiconductor memory from which data is read out and to which data is written; and a data managing unit that manages an operation state of the memory system, wherein the data managing unit includes: a data transfer unit that performs data transfer between a host apparatus and the second storing area via the first storing area; a management-information managing unit that writes internal information concerning an operation state of the memory system in a special LBA area allocated to a predetermined logical address range in the second storing area and writes the internal information in the first storing area, and stores, when a predetermined condition is satisfied, the internal information written in the first storing area in the second storing area as a snapshot; and a management-information restoring unit that reads out, when the memory system is started up, the internal information written in the special LEA area and captures the internal information stored in the second storing area as the snapshot into the first storing area, and reads out the internal information captured into the first storing area when an error occurs and the internal information written in the special LBA area cannot be read out when the memory system is started up.

According to still another aspect of the present invention, there is provided a memory initializing method comprising performing, using a first storing area included in a volatile semiconductor memory from which data is read out and to which data is written and a second storing area included in a nonvolatile semiconductor memory from which data is read out and to which data is written, data transfer between a host apparatus and the second storing area via the first storing area; writing internal information concerning an operation state of the memory system in a special LBA area allocated to a predetermined logical address range in the second storing area and writing the internal information in the first storing area;

storing the internal information written in the first storing area in the second storing area as a snapshot when a predetermined condition is satisfied; capturing, when the memory system is started up, the internal information stored in the second storing area as the snapshot into the first storing area; and reading out the internal information captured into the first storing area when an error occurs and the internal information written in the special LBA area cannot be read out when the memory system is started up.

### BRIEF DESCRIPTION OF THE DRAWINGS

FIG. 1 is a block diagram of an example of a configuration of a memory system according to a first embodiment of the present invention;

FIG. 2 is a circuit diagram of an example of a configuration of one block included in a NAND memory;

FIG. 3 is a schematic diagram of functional configurations of a DRAM and the NAND memory;

FIG. 4 is a diagram of an example of a layer structure for managing data stored in the memory system;

FIG. 5 is a diagram of an example of cache management information;

FIG. 6 is a diagram of an example of logical NAND management information;

FIG. 7 is a diagram of an example of intra-NAND logical-to-physical conversion information;

FIG. 8 is a schematic diagram of an example of contents of management information storage information stored in a management information storage area;

FIG. 9 is a diagram of an example of a log;

FIG. 10 is a block diagram of an example of a functional configuration of a drive control circuit;

FIG. 11 is a block diagram of an example of a functional configuration of a data managing unit according to the embodiment;

FIG. 12 is a flowchart of an example of a storage processing procedure for management information of the memory system;

FIG. 13 is a flowchart of an example of a restoration processing procedure for management information of the memory system;

FIG. 14 is a block diagram of a hardware internal configuration example of the drive control circuit;

FIG. 15 is a schematic diagram of sections of a storage area of the NAND memory;

FIG. 16 is a schematic diagram of sections of a snapshot area;

FIG. 17 is a flowchart of storage processing for AM management information;

FIG. 18 is a flowchart of a processing procedure of initialization processing;

FIG. 19 is a perspective view of an example of a personal computer mounted with the memory system; and

FIG. 20 is a diagram of a system configuration example of the personal computer mounted with the memory system.

### DETAILED DESCRIPTION OF THE INVENTION

Embodiments of the present invention are explained below with reference to the accompanying drawings. In the following explanation, components having the same functions and configurations are denoted by the same reference numerals and signs. Redundant explanation of the components is made only when necessary. The present invention is not limited by the embodiments.

### First Embodiment

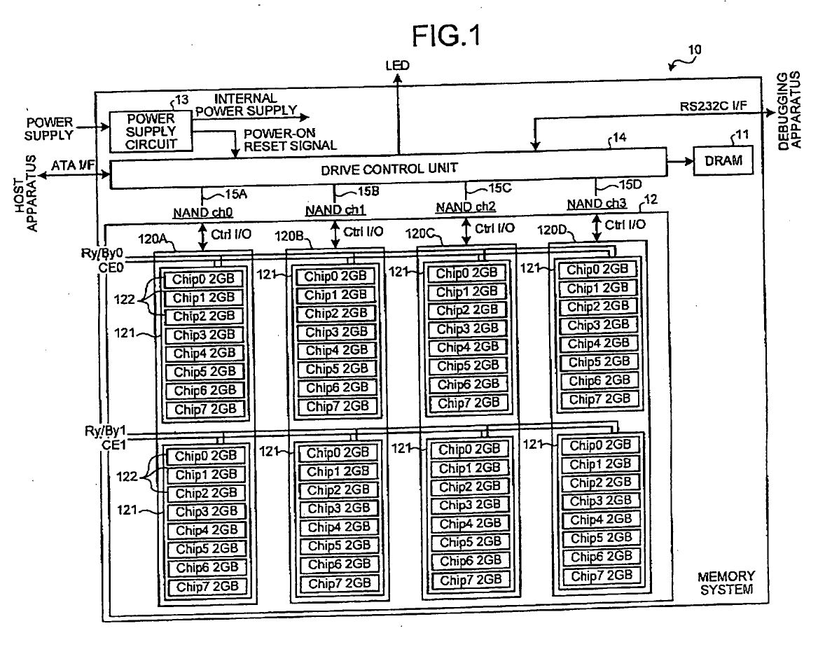

The memory system includes a nonvolatile semiconductor storage device and is used as a secondary storage device (SSD: Solid State Drive) of a host apparatus such as a personal computer. The memory system has a function or storing data requested by a host apparatus to be written and reading out data requested by the host apparatus to be read out and outputting the data to the host apparatus. FIG. 1 is a block diagram of an example of a configuration of a memory system 10 according to the first embodiment. This memory system 10 includes a DRAM (Dynamic Random Access Memory) 11 as a first storing unit, a NAND flash memory (hereinafter, “NAND memory”) 12 as a second storing unit, a power supply circuit 13, and a drive control unit 14 as a controller.

The DRAM 11 as a volatile semiconductor is used as a storing unit for data transfer, management information recording, or a work area. Specifically, when the DRAM 11 is used as a storing unit for data transfer, the DRAM 11 is used for temporarily storing data requested by the host apparatus to be written before the data is written in the NAND memory 12, and the DRAM 11 is used to read out data requested by the host apparatus to be read out from the NAND memory 12 and temporarily storing the read data. When the DRAM 11 is used as a storing unit for management information recording, the DRAM 11 is used for storing management information for managing storage positions of data stored in the DRAM 11 and the NAND memory 12. When the DRAM 11 is used as a storing unit for a work area, the DRAM 11 is used, for example, during expansion of logs used when management information is restored.

The NAND memory 12 as a non-volatile semiconductor is used as a storing unit for storing therein data, specifically, the NAND memory 12 stores therein data designated by the host apparatus and stores therein, for backup, management information managed by the DRAM 11. In FIG. 1, the NAND memory 12 that includes four channels 120A to 120D has been shown as an example. Each of the channels 120A to 120D includes two packages 121 each including eight chips 122 having a storage capacity of a predetermined size. The channels 120A to 120D are connected via the drive control unit 14 and buses 15A to 15D. The number of channels, the number of chips, and a connection relation among signal lines are not limited to an example shown in FIG. 1.

The power supply circuit 13 receives external power supply and generates a plurality of internal power supplies to be supplied to respective units of the memory system 10 from the external power supply. The power supply circuit 13 detects a state of the external power supply, i.e., a rising edge, and generates a power-on reset signal based on the detected state, and outputs the power-on reset signal to the drive control unit 14.

The drive control unit 14 controls the DRAM 11 and the NAND memory 12. As explained in detail later, for example, the drive control unit 14 performs restoration processing for management information and storage processing for management information according to the power-on reset signal from the power supply circuit 13. The drive control unit 14 transmits and receives data to and from a host apparatus via an ATA interface (I/F) and transmits and receives data to and from a debugging apparatus via an RS232C I/F. Furthermore, the drive control unit 14 outputs a control signal for controlling on/off of an LED for state display provided on the outside of the memory system 10.

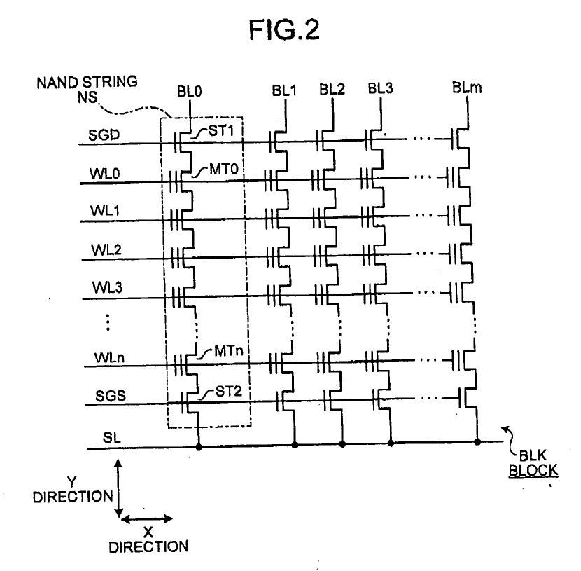

A configuration of the NAND memory 12 is explained in detail below. The NAND memory 12 is configured by arraying a plurality of blocks (erasing unit areas), which are units of data erasing, on a substrate. FIG. 2 is a circuit diagram of an example of a configuration of an arbitrary block of the NAND memory 12. In FIG. 2, left-right direction is set as an X direction and a direction perpendicular to the X direction is set as a Y direction.

Each block BLK of the NAND memory 12 includes (m+1) (m is an integer equal to or larger than 0) NAND strings NS arrayed in order along the X direction. Each NAND string NS has (n+1) (n is an integer equal to or larger than 0) memory cell transistors MT0 to MTn that share a diffusion region (a source region or a drain region) between memory cell transistors MT adjacent to each other in the Y direction. Moreover, the memory cell transistors MT0 to MTn are connected in series in the Y direction. In addition, selection transistors ST1 and ST2 arranged at both ends of a row of the (n+1) memory transistors MT0 to MTn.

Each memory cell transistors MT0 to MTn is a MOSFET (Metal Oxide Semiconductor Field Effect Transistor) having a stacked gate structure formed on a semiconductor substrate. The stacked gate structure includes a charge accumulation layer (a floating gate electrode) formed on the semiconductor substrate via a gate insulating film and a control gate electrode formed on the charge accumulating layer via an inter-gate insulating film. Moreover, the memory cell transistors MT0 to MTn are multi-value memories in which a threshold voltage changes according to the number of electrons accumulated in the floating gate electrode and 2 or more bit data can be stored depending on the difference in the threshold voltage.

In the embodiments explained below, as an example, the memory cell transistors MT are the multi-value memories. However, the memory cell transistors MT can be configured to store one bit (two values).

Word lines WL0 to WLn are respectively connected to the control gate electrodes of the memory cell transistors MT0 to MTn of each NAND string NS. Memory cell transistors MTi (i=0 to n) in each of the NAND strings NS are connected in common by the same word lines (i=0 to n). In other words, the control gate electrodes of the memory cell transistors MTi present on the same row in the block BLK are connected to the same word line WLi. An array of (m+1) memory cell transistors MTi connected to the same word line WLi is treated as one page. In the NAND memory 12, writing and readout of data are performed in units of a page. When the memory cell transistors can store 2-bit data, two pages (a lower page and an upper page) are allocated to the sane word line WLi.

Bit lines BL0 to BLm are respectively connected to drains of the (m+1) selection transistors ST1 in one block BLK. A selection gate line SGD is connected in common to gates of the selection transistors ST1 of each NAND string NS, Sources of the selection transistors ST1 are connected to drains of the memory cell transistors MT0. Similarly, a source line SL is connected in common to sources of the (m+1) selection transistors ST2 in one block BLK. A selection gate line SGS is connected in common to gates of the selection transistors ST2 of each NAND string NS. Drains of the selection transistors ST2 are connected to sources of the memory cell transistors MTn.

Although not shown in the figure, bit lines BLj (j=0 to m) in one block BLK connect drains of the selection transistors ST1 in common between bit lines BLj of other blocks BLK. In other words, the NAND strings NS in the same column in the blocks BLK are connected by the same bit line BLj. In this embodiment, data writing in the NAND memory 12 is performed in a write-once system (a sequential system). In other words, rewriting in the same page is possible only after an entire block including the page is erased.

In the NAND memory 12, as explained above, the minimum unit of writing and readout is one page in the memory cell transistor MTi group connected to the same word line WLi. The minimum unit of erasing is one block including a predetermined number of pages (hereinafter, “physical block”). A plurality of the blocks form a plane. A plurality of the planes form one chip 122. A plurality of chips 122 form channel corresponding storage areas 120A to 120D. A plurality of the channel corresponding storage areas 120A to 120D form one NAND memory 12. In an example explained below, the number of channels is four (channels 0 to 3) and the number of planes is two (planes 0 and 1).

In this memory system, the channel corresponding storage areas 120A to 120D are connected to the drive control unit 14 in parallel. Therefore, it is possible to cause a plurality of channels in parallel and cause only one channel to operate.

In some case, writing and readout processing is performed in parallel with a predetermined number of physical blocks as a unit or erasing is performed in parallel according to setting of the drive control unit 14. A set of the predetermined number of physical blocks is referred to as logical block. The logical block is formed by, for example, selecting one physical block belonging to the same chip number and the same plane number from each of the different channel corresponding storage areas 120A to 120D. A set of four physical pages of the respective physical blocks in the logical block can form a logical page to perform parallel access to the physical pages.

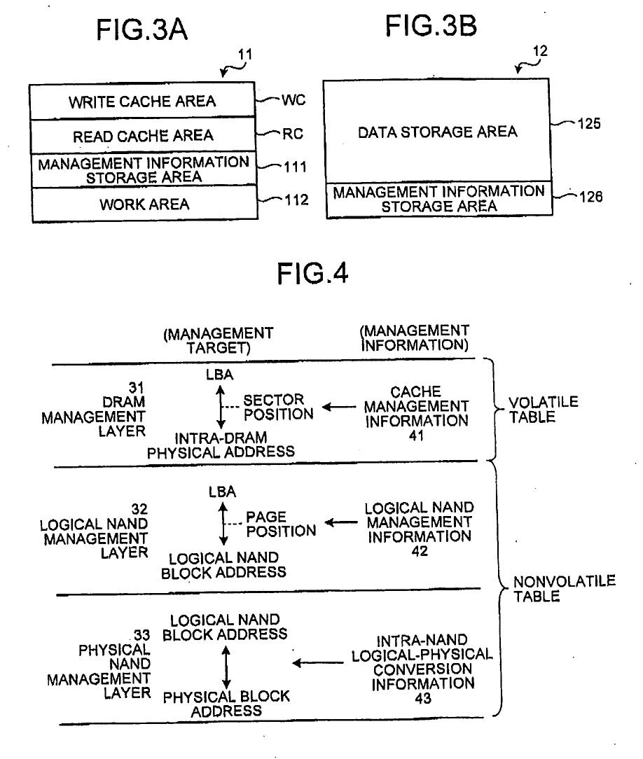

Functional configurations of the DRAM 11 and the NAND memory 12 are explained next. FIG. 3A is a schematic diagram of a functional configuration of the DRAM 11 and FIG. 3B is a schematic diagram of a functional configuration of the NAND memory 12. As shown in FIG. 3A, the DRAM 11 includes a write cache area in which data requested by the host apparatus to be written is stored, a read cache area RC in which data requested by the host apparatus to be read out is stored, a management information storage area 111 in which management information for managing storage positions of data stored in the DRAM 11 and the NAND memory 12 is stored, and a work area 112 used when the management information is restored.

As shown in FIG. 3B, the NAND memory 12 includes a data storage area 125 in which data requested by the host apparatus to be written is stored and a management information storage area 126 in which the management information managed in the management information storage area 111 of the DRAM 11 is stored. In the management information storage area 126, as the management information, a snapshot explained later, a log, a pointer 230 explained later, and the like are stored. In this example, a data writing and readout unit in the NAND memory 12 is set as a page size unit (physical page size). An erasing unit is set as a block size (physical block size) unit (e.g., 512 KB). Therefore, an area for storing respective blocks of the NAND memory 12 managed in block size units is further divided into areas of page size units. When the page size is 4 KB and the block size is 512 KB, then a block contains 128 pages.

The management information managed in the management information storage area 111 of the DRAM 11 is explained below. FIG. 4 is a diagram of an example of a layer structure for managing data stored in the memory system 10. It is assumed here that this data is the data requested by the host apparatus to be written or read out. In the memory system 10, data management is performed by a three-layer structure: a DRAM management layer 31, a logical NAND management layer 32, and a physical NAND management layer 33. The DRAM management layer 31 performs data management in the DRAM 11 that plays a role of a cache. The logical NAND management layer 32 performs logical data management in the NAND memory 12. The physical NAND management layer 33 performs physical data management in the NAND memory 12, life extension processing for the NAND memory 12, and the like.

In the write cache area WC and the read cache area RC of the DRAM 11, data designated by a logical address (hereinafter, “LBA (Logical Block Address)”) managed by an address managing method of the host apparatus is stored in a physical address in a predetermined range on the DRAM 11 (hereinafter, “intra-DRAM physical address). Data in the DRAM management layer 31 is managed by cache management information 41 including a correspondence relation between an LBA of data to be stored and the intra-DRAM physical address and a sector flag indicating presence or absence of data in sector size units in a page.

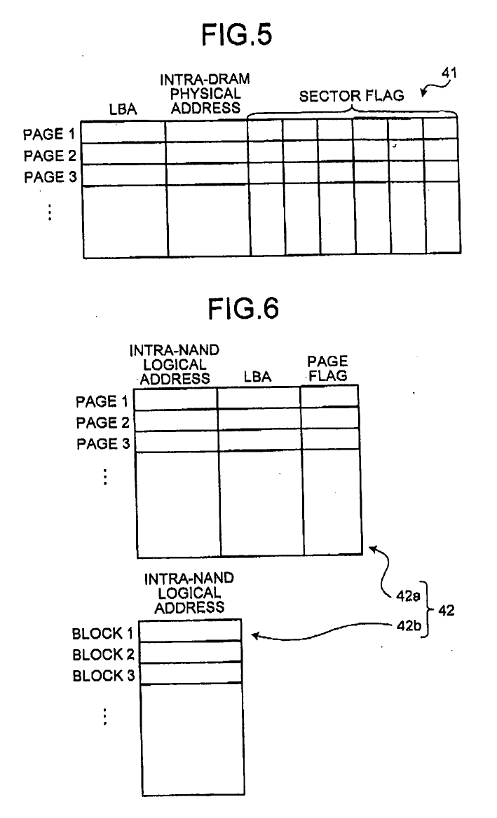

FIG. 5 illustrates an example of the cache management information 41 in tabular manner. The cache management information 41 is one entry for one area of a one page size of the NAND memory 12. The number of entries is equal to or smaller than the number of pages that fit in the write cache area WC and the read cache area RC. In each of the entries, the LBA of data of a page size, the intra-DRAM physical address, and a sector flag indicating a position of valid data in each of areas obtained by dividing this page by a sector size are associated.

In the NAND memory 12, data received from the DRAM 11 is stored in a physical address in a predetermined range (hereinafter, “intra-NAND physical address”) on the NAND memory 12. As explained above, in the NAND memory 12, data writing and readout is performed in page units and data erasing is performed in block units. In the NAND memory 12 formed by the multi-value memory, because the number of rewritable times is limited, the numbers of times of rewriting among the blocks configuring the NAND memory 12 are controlled by the drive control unit 14 to be equalized. In other words, when update of data written in a certain intra-NAND physical address in the NAND memory 12 is performed, the drive control unit 14 performs control to equalize the numbers of times of rewriting among the blocks configuring the NAND memory 12 to write, in a block different from the original block, data reflecting a portion required to be updated of a block in which the data to be updated is included and invalidate the original block.

As explained above, in the NAND memory 12, processing units are different in the writing and readout processing for data and the erasing processing for data. In the update processing for data, a position (a block) of data before update and a position (a block) of data after update are different. Therefore, in the first embodiment, an intra-NAND logical address used independently in the NAND memory 12 (hereinafter, “intra-NAND logical address”) is provided besides the intra-NAND physical address.

Therefore, data in the logical NAND management layer 32 is managed by logical NAND management information 42 indicating a relation between an LBA of data in page size units received from the DRAM 11 and an intra-NAND logical address indicating a logical page position of the NAND memory 12 in which the received data is stored and a relation indicating an address range of a logical block having a size coinciding with that of a block as an erasing unit in the NAND memory 12. A collection of a plurality of the logical blocks can be set as a logical block. Data in the physical NAND management layer 33 is managed by intra-NAND logical address-physical address conversion information (hereinafter, “logical-physical conversion information) including a correspondence relation between the intra-NAND logical address and the intra-NAND physical address in the NAND memory 12.

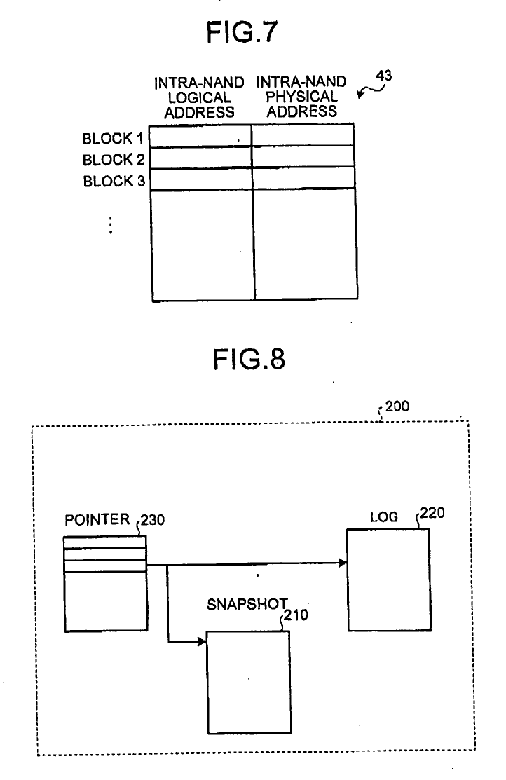

FIG. 6 illustrates an example of the logical NAND management information 42 in tabular manner. FIG. 7 illustrates an example of intra-NAND logical-physical conversion information 43 in tabular manner. As shown in FIG. 6, the logical NAND management information 42 includes logical page management information 42a and logical block management information 42b. The logical page management information 42a has one entry for one logical area of a one page size. Each of entries includes an LBA of data of the one page size, an intra-NAND logical address, and a page flag indicating whether this page is valid. The logical block management information 42b includes an intra-NAND logical address set for a logical area of the one block size of the NAND memory 12. As shown in FIG. 7, in the intra-NAND logical-physical conversion information 43, the intra-NAND physical address and the inter-NAND logical address of the NAND memory 12 are associated.

By using these kinds of management information, a correspondence of the LBA used in the host apparatus, the intra-NAND logical address used in the NAND memory 12, and the intra-NAND physical address used in the NAND memory 12 can be established. This makes it is possible to exchange data between the host apparatus and the memory system 10.

The management information managed by the DRAM management layer 31 is lost because of power-off or the like so that this management information can be called a volatile table. On the contrary, if the management information managed by the logical NAND management layer 32 and the physical NAND management layer 33 is lost because of power-off or the like, the lost management information hinders successful startup of the memory system 10 so that measures are required to be taken such that the management information is stored even in the event of power-off or the like. Therefore, this management information can be called a nonvolatile table.

This nonvolatile table manages data stored in the NAND memory 12. If the nonvolatile table is not present, information stored in the NAND memory 12 cannot be accessed or data stored in an area is erased. Therefore, the nonvolatile table needs to be stored as latest information in preparation for sudden power-off. Therefore, in the first embodiment, management information including at least the nonvolatile table is stored in the latest state in the management information storage area 126 of the NAND memory 12. The management information storage information stored in the management information storage area 126 of the NAND memory 12 is explained below. The following explanation assumes that only the nonvolatile table is stored in the management information storage area 126.

FIG. 8 is a schematic diagram of an example of contents of management information storage information stored in the management information storage area 126. In this management information storage information 200, a snapshot 210 as contents of the nonvolatile table at a certain point, a log 220 as difference information between the nonvolatile table after the contents of the nonvolatile table are changed and the snapshot 210 (or the snapshot 210 and a log already generated), and management information position indication information (hereinafter, “pointer”) 230 indicating positions of the snapshot 210 and the log 220 acquired first concerning the snap shot 210 are stored. The snapshot 210 means information obtained by storing management information including at least the nonvolatile table at a predetermined point among the kinds of management information stored in the management information storage area 111 of the DRAM 11.

In FIG. 8, the snapshot 210, the log 220, and the pointer 230 are stored in different blocks, respectively. The snapshot 210 is stored in a block for snapshot storage. The snapshot 210 includes the logical NAND management information 42 and the intra-NAND logical-to-physical conversion information 43 as nonvolatile tables in the management information storage area 126 of the NAND memory 12. When a new snapshot 210 is stored, the snapshot 210 is stored in a block different from that of the snapshot 210 stored before.

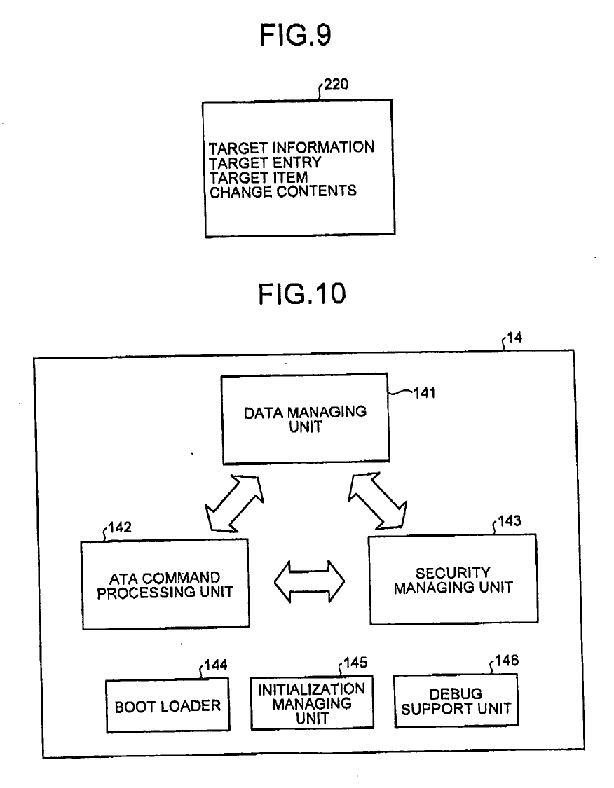

The log 220 is stored in a log storing block. The log 220 is continuously written in the same log storing block even when a generation of the snapshot 210 changes. FIG. 9 is a diagram of an example of the log 220. The log 220 includes target information to be management information of a change target, a target entry as an entry to be a change target in the target information, a target item as an item to be a change target in the target entry, and change contents as contents of a change of the target item.

The pointer 230 is stored in an instruction information storage block. The pointer 230 only has to be a pointer that indicates a top address of a block indicating storage positions of the snapshot 210, and the log 220. However, a portion indicating a storage position of the snapshot 210 in the pointer 230 can be a portion that indicates top addresses of respective kinds of management information included in the snapshot 210. The pointer 230 is updated when the snapshot 210 is stored anew or when a snapshot storing block or a log storing block is changed. Pointers of the log 220 can be stored in the snapshot 210 rather than in the instruction information storing block.

Functions of the drive control unit 14 are explained below. FIG. 10 is a block diagram of an example of a functional configuration of the drive control circuit 14. The drive control unit 14 includes a data managing unit 141, an ATA command processing unit 142, a security managing unit 143, a boot loader 144, an initialization managing unit 145, and a debug support unit 146. The data managing unit 141 performs data transfer between the DRAM 11 and the NAND memory 12 and control of various functions concerning the NAND memory 12. The ATA command processing unit 142 performs data transfer processing in cooperation with the data managing unit 141 based on an instruction received from the ATA interface. The security managing unit 143 manages various kinds of security information in cooperation with the data managing unit 141 and the ATA command processing unit 142. The boot loader 144 loads respective management programs (FW) from the NAND memory 12 to a not shown memory (e.g., an SRAM (Static RAM)) during power-on. The initialization managing unit 145 performs initialization of respective controllers and circuits in the drive control unit 14. The debug support unit 146 processes debug data supplied from the outside via the RS232C interface.

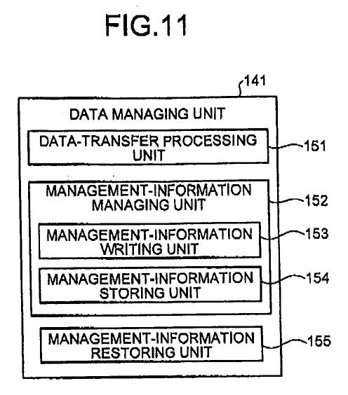

FIG. 11 is a block diagram of an example of a functional configuration of a data managing unit 141. The data managing unit 141 includes a data-transfer processing unit 151 that performs data transfer between the DRAM 11 and the NAND memory 12, a management-information managing unit 152 that performs change and storage of management information according to a change of data stored in the DRAM 11 and the NAND memory 12, and a management-information restoring unit 155 that restores latest management information based on management information stored during power-on or the like.

The management-information managing unit 152 includes a management-information writing unit 153 and a management-information storing unit 154. The management-information writing unit 153 performs update of the management information stored in the DRAM 11 when update of the management information is necessary according to the change processing for data stored in the DRAM 11 or the NAND memory 12 by the data-transfer processing unit 151.

When the memory system 10 satisfies predetermined conditions, the management-information storing unit 154 stores, in the management information storage area 126 of the NAND memory 12, the management information as the snapshot 210 and stores updated information in the management information as the log 220. When a position of writing in the pointer 230 is changed according to storage of the snapshot 210 or the log 220, the management information storing unit 154 applies update processing to the pointer 230.

The storage of the snapshot 210 by the management-information storing unit 154 is executed according to a predetermined situation of the memory system, for example, when a log storage area provided for storing the log 220 in the management information storage area 126 of the NAND memory 12 is filled (the area is filled with data).

The storage of the log 220 by the management-information storing unit 154 is executed at the time of data update on the NAND memory 12 involving update of the management table (the nonvolatile table) stored in the DRAM 11 (when data writing in the NAND memory 12 is necessary).

When the memory system 10 is started up, the management-information restoring unit 155 performs restoration processing for management information based on the management information storage information stored in the management information storage area 126 of the NAND memory 12. Specifically, the management-information restoring unit 155 traces the pointer 230, the snapshot 210, and the log 220 in order and determines whether the log 220 corresponding to the latest snapshot 210 is present. When the log 220 is not present, the management-information restoring unit 155 restores, in the DRAM 11, the snapshot 210 of the snapshot storing block as management information. When the log 220 is present, the end of the memory system 10 is an abnormal end such as a program error or short break. Therefore, the management-information restoring unit 155 acquires the snapshot 210 from the snapshot storing block, acquires the log 220 from the log storing block, and performs restoration of the management information (the nonvolatile table) reflecting the log 220 on the snapshot 210 on the DRAM 11.

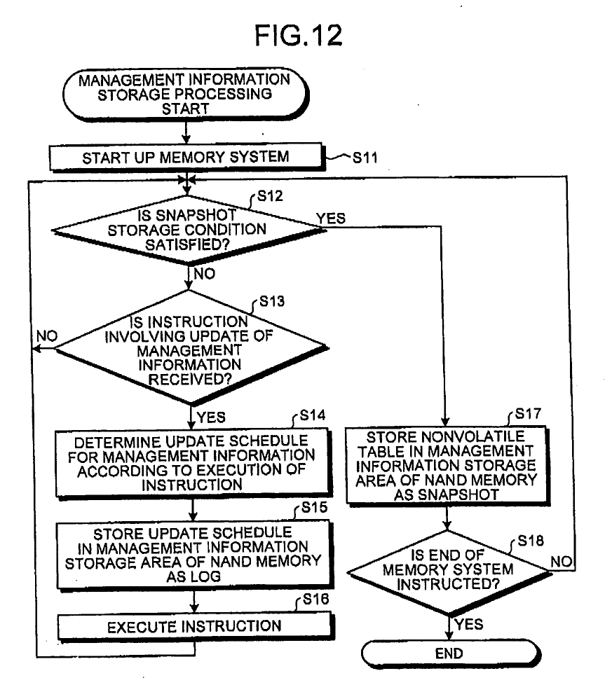

The storage processing for management information of the memory system 10 by the management-information managing unit 152 is explained. FIG. 12 is a flowchart of an example of a storage processing procedure for management information of the memory system. The memory system 10 is connected to the host apparatus and operates as a secondary storage device of the host apparatus. The host apparatus is in a startup state. The snapshot 210 is stored before the stop of the memory system 10 before the startup state.

First, the host apparatus is in a started state based on the snapshot 210 stored at the last end of the host apparatus (step S11). Subsequently, the management-information managing unit 152 determines whether a snapshot storage condition is satisfied (step S12). When the snapshot storage condition is not satisfied (“No” at step S12), the management-information managing unit 152 determines whether an instruction involving update of the management information is received (step S13). When the instruction involving update of the management information is not received (“No” at step S13), the management-information managing unit 152 returns to step S12.

When the instruction involving update of the management information is received (“Yes” at step S13), the management-information managing unit 152 determines an update schedule indicating how the management information is updated by executing the instruction (step S14). The management-information managing unit 152 stores the update schedule in the log storing block of the management information storage area 126 of the NAND memory 12 as the log 220 (step S15). When the log 220 is not stored in the log storing block, the update schedule (the log) is difference information between the nonvolatile table at the present point and the snapshot 210 stored in the snapshot storing block. When the log (hereinafter, “log in the past”) is already stored in the log storing block, the update schedule (the log) is difference information between the nonvolatile table at the present point and a combination of the snapshot 210 and the log in the past. The log 220 is stored in the management information storage area 126 of the NAND memory 12, for example, after the log 220 (the update schedule) is recorded on the DRAM 11.

Subsequently, the logical NAND management layer executes the instruction received at step S13 (step S16). As an example of such an instruction, there is writing processing for user data in a predetermined block of the data storage area of the NAND memory 12. Thereafter, the management-information managing unit 152 returns to step S12.

When the snapshot storage condition is satisfied at step S12 (“Yes” at step S12). The management-information managing unit 152 stores the management information including at least the nonvolatile table in the management information storage area 111 of the DRAM 11 in the management information storage area 126 of the NAND memory 12 as the snapshot 210 (step S17). The management-information-managing unit 152 determines whether the end of the memory system 10 is instructed (step S18). When the end of the memory system 10 is not instructed, the management-information managing unit 152 returns to step S12. When the end of the memory system 10 is instructed, the processing is directly finished.

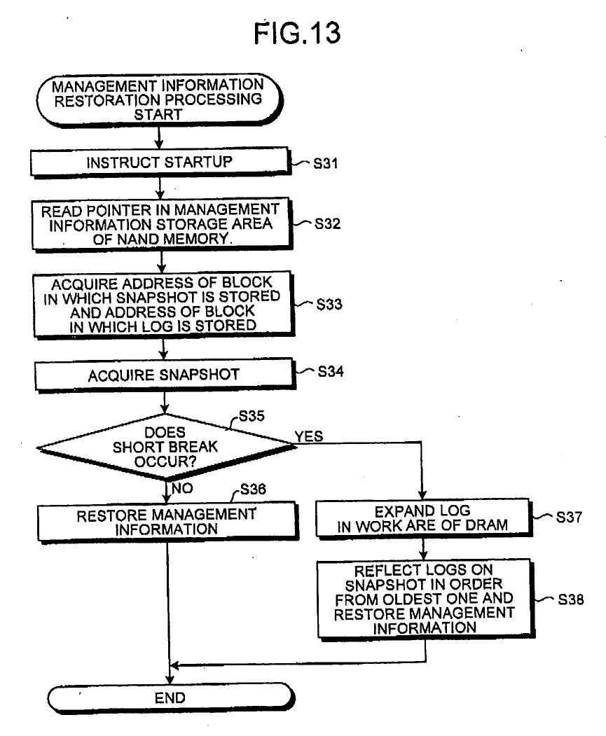

Restoration processing for management information of the memory system 10 by the management-information restoring unit 155 is explained. FIG. 13 is a flowchart of an example of a restoration processing procedure for management information of the memory system. The memory system 10 is connected to the host apparatus and operates as the secondary storage device of the host apparatus.

First, the power supply of the host apparatus is turned on and a startup instruction is issued to the memory system 10 (step S31). The management-information restoring unit 155 reads the pointer in the management information storage area 126 of the NAND memory 12 (step S32) and acquires an address of a block in which the snapshot 210 is stored and an address of a block in which the log 220 is stored (step S33).

Subsequently, the management-information restoring unit 155 reads the snapshot 210 from the address in the NAND memory 12 acquired at step S33 and restores the snapshot 210 in the temporary storage area 111 of the DRAM 11 (step S34).

Thereafter, the management-information restoring unit 155 determines whether short break occurs referring to the log 220 in the NAND memory 12 (step S35). When short break does not occur (“No” at step S35), the management-information restoring unit 155 restores the management information from the snapshot 210 restored in the temporary storage area 111 of the DRAM 11 at step S34 (step S36). The restoration processing is finished.

On the other hand, when short break occurs (“Yes” at step S35), the management-information restoring unit 155 expands the log 220 in the storage position acquired at step S33 in the work area 112 of the DRAM 11 (step S37) and restores the management information reflecting logs on the snapshot 210 in order from the oldest log 220 (step S38). The restoration processing is finished.

A main part of this embodiment is explained. In this embodiment, a part of an area stored as the snapshot 210 of the storage area on the DRAM 11 is secured as an area for storing data (tables, variables, etc.) that the AM desires to back up. In the following explanation, the data managing unit 141, the boot loader 144, and the debug support unit 146 explained with reference to FIG. 10 are referred to as DM (data manager), the ATA-command processing unit 142 is referred to as AM (ATA manager), and the initialization managing unit 145 is referred to as IM (initialize manager).

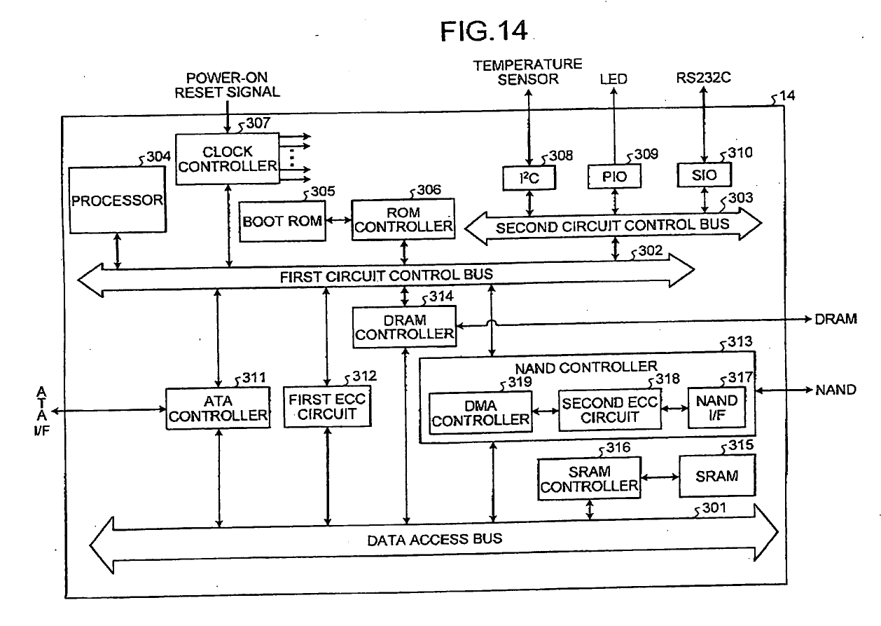

FIG. 14 is a block diagram of a hardware internal configuration example of the drive control unit 14. The drive control unit 14 includes a data access bus 301, a first circuit control bus 302, and a second circuit control bus 303. A processor 304 that controls the entire drive control unit 14 is connected to the first circuit control bus 302. A boot ROM 305 in which a boot program for booting management programs (firmware (FW)) stored in the NAND memory 12 is stored is connected to the first circuit control bus 302 via a ROM controller 306. A clock controller 307 that receives a power-on reset signal from the power supply circuit 13 shown in FIG. 1 and supplies a reset signal and a clock signal to the respective units is connected to the first circuit control bus 302.

The second circuit control bus 303 is connected to the first circuit control bus 302. An I²C circuit 308 for receiving data from a temperature sensor, a parallel IO (PIO) circuit 309 for supplying a status display signal to an LED for state display, and a serial 10 (SIO) circuit 310 for controlling an RS232C interface (I/F) are connected to the second circuit control bus 303.

An ATA interface controller (ATA controller) 311, a first Error Checking and Correction (ECC) circuit 312, a NAND controller 313, and a DRAM controller 314 are connected to both the data access bus 301 and the first circuit control bus 302. The ATA controller 311 transmits and receives data to and from the host apparatus via an ATA interface. A static random access memory (SRAM) 315 used as a data word area and a firmware expansion area is connected to the data access bus 301 via an SPAM controller 316. When the memory system 10 is started up, the firmware stored in the NAND memory 12 is transferred to the SRAM 315, by the boot program stored in the boot ROM 305.

The NAND controller 313 includes a NAND I/F 317 that performs interface processing for interface with the NAND memory 12, a second ECC circuit 318, and a DMA controller 319 for DNA transfer control for performing access control between the NAND memory 12 and the DRAM 11. The second ECC circuit 318 performs encoding of a second error correction code and performs encoding and decoding of a first error correction code. The first ECC circuit 312 performs decoding of the second error correction code. The first error correction code and the second error correction code are, for example, a humming code, a Bose Chaudhuri Hocquenghen (BCH) code, a Reed Solomon (RS) code, or a Low Density Parity Check (LDPC) code. Correction ability of the second error correction code is higher than that of the first error correction code.

When data transfer between the DRAM 11 and the NAND memory 12 is performed by the drive control unit 14 shown in FIG. 10, the data transfer is performed via the NAND controller 313 and the first ECC circuit 312. When data transfer processing between the DRAM 11 and the host apparatus is performed by the ATA command processing unit 142, the data transfer is performed via the ATA controller 311 and the DRAM controller 314.

A storage area of the NAND memory 12 is explained.

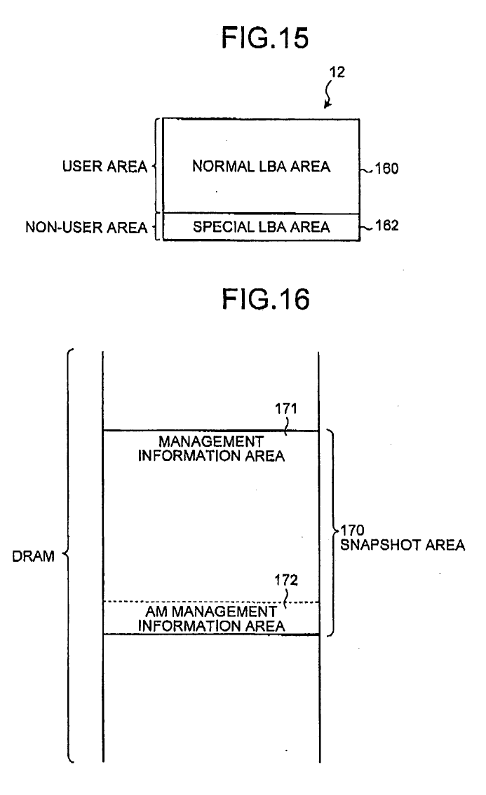

FIG. 15 is a schematic diagram of sections of the storage area of the NAND memory 12 from the viewpoint of the host apparatus. As shown in FIG. 15, the storage area of the NAND memory 12 is sectioned into a normal LBA area 160 and a special LBA area 162. Whereas the normal LBA area 160 is an area accessible by a command (a Read command, a Write command, etc.) from the host apparatus 1, the special LBA area 162 is an LBA area (a host access prohibited area) not accessible according to a normal command issued from the host apparatus 1. The data storage area 125 and the management information storage area 126 shown in FIG. 3A are areas in the normal LBA area 160. The special LBA area 162 is accessible by a command issued by a module configuring firmware (FW) expanded in the inside of the memory system 10.

The normal LBA area 160 and the special LBA area 162 are explained with reference to a specific example. If the size (a so-called disk capacity) of an area of the memory system 10 is, for example, 128 GB, this 128 GB area is a user area. On the other hand, in the memory system 10, besides the 129 GB area (the user area) accessible from the host apparatus 1, an area (a non-user area) of a predetermined size (e.g., equivalent to about one logical block) is mapped onto an LBA as an area for storing internal information of the SSD 100. The 128 GB area is a normal LBA area and the area of the predetermined size is a special LBA area.

The special LBA area 162 stores management data for managing the memory system 10. When the memory system 10 is started up, the management data is expanded in the DRAM 11. The special LBA area 162 is usually implemented to be added behind the user data area to prevent the special LBA area 162 from being accessed by mistake by a command from the host apparatus 1. However, the special LBA area 162 can be handled in a management system same as that for the user data stored in the normal LBA area 160 and can be allocated to all NAND blocks to which the normal LBA area 160 can be mapped. In other words, from the viewpoint of the logical NAND management layer 32, there is no different of processing except a difference in a logical address. Naturally, the special LBA area 162 is also a target of wear leveling.

The aim of providing the special LBA area 162 is explained. As explained above, in the secondary storage device including the hard disk, the initialization processing for the user area is performed by using the physical format and the logical format. In the initialization processing, it is necessary to manage data in the non-user area not to be erased. In the memory system 10 according to this embodiment, to realize the functions of the physical format and the logical format, the concept of the special LBA area 162 is introduced and an area based on the concept is provided in the NAN memory 12.

An area (a snapshot area) stored from the DRAM 11 in the NAND memory 12 as the snapshot 210 is explained. FIG. 16 is a schematic diagram of sections of the snapshot area.

On the DRAM 11, a snapshot area 170 includes, for example, an 8 MB area. In this embodiment, the snapshot area 170 includes a management information area 171 and an AM management information area 172.

The management information area 171 is an area for storing various kinds of management information such as the cache management information 41, the logical NAND management information 42, and the intra-NAND logical-to-physical conversion information 43 shown in FIG. 4. The AM management information area 172 is an area for storing tables, variables, and the like, which the AM (the ATA manager) desires to back up, as AM management information (internal information concerning an operation state of the memory system 10, e.g., Self-Monitoring Analysis and Reporting Technology (SMART) information). The AM management information that the AM desires to back up is data (AM management information) stored in the special LBA area 162 of the NAND memory 12.

The special LBA area 162 managed by the AM is an area for storing data important on the memory system 10. Therefore, in this embodiment, even when error correction (error correction of an L2-ECC error explained later) for data in the special LBA area 162 cannot be performed, the AM management information is restored by using the snapshot 210 stored as the backup.

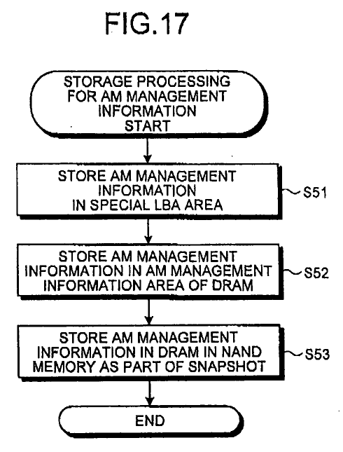

Processing procedures of storage processing and initialization processing for the AM management information are explained. FIG. 17 is a flowchart of the storage processing for the AM management information. The AM stores the AM management information on the DRAM 11 in the special LBA area 162 using a Write command or the like provided from the DM. Specifically, when statistical information (temperature information, etc.), a warning event history, time information, and the like internal to the memory system 10 are updated or when an amount of updated information exceeds a predetermined amount, the AM stores the statistical information, the warning event history, the time information, and the like in the special LBA area 162 as AM management information (step S51). For example, important information such as the warning event history is stored in the special LBA area 162 at any time. Information with low importance such as the statistical information is stored in the special LBA area 162 when an update difference exceeds the predetermined amount. Further, the AM copies the AM management information stored in the special LBA area 162 and stores the AM management information in the AM management information area 172 of the DRAM 11 (step S52).

As explained above, in this embodiment, a part of the DRAM area for the snapshot 210, which the DM stores at predetermined timing, is opened to the AM. The AM management information is copied to this area.

Thereafter, when conditions for storing the snapshot 210 are satisfied, the DM stores the AM management information in the DRAM 11 (the AM management information area 172) in the NAND memory 12 as a part of the snapshot 210 (step S53). In other words, the DM stores, in the NAND memory 12, the management information such as the cache management information 41 stored in the management information area 171 and the AM management information stored in the AM management information area 172.

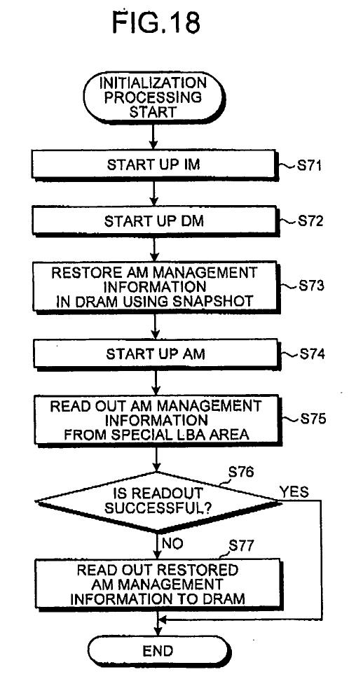

FIG. 18 is a flowchart of a processing procedure of the initialization processing. As the initialization processing for the memory system 10, first, startup processing for the IM is performed (step S71). As the startup processing, the IM sends an initialization instruction to the controllers and the circuits in the drive control unit 14.

Startup processing for the DM is performed (step S72). As the startup processing, the DM restores the snapshot 210 stored in the NAND memory 12 in the DRAM 11. Consequently, the AM management information stored in the AM management information area 172 in the snapshot 210 is restored on the DRAM 11 (step S73).

Startup processing for the AM is performed (step S74). As the startup processing, the AM reads out the AM management information from the special LBA area 162 using a Read command provided from the DM (step S75). The AM determines whether the AM succeeds in readout of the AM management information from the special LBA area 162 (step S76).

When the AM fails in readout of the AM management information from the special LBA area 162 because of occurrence of an L2-ECC error (error correction cannot be performed by the second ECC circuit 317 and the first ECC circuit 311) (“No” at step S76), the AM reads out the AM management information restored on the DRAM 11 from the AM management information area 172 (step S77). In other words, when the L2-ECC error or the like occurs and the AM management information cannot be read out from the special LBA area 162, instead of initializing the AM management information area 172 according to the AM management information read out from the special LBA area 162, the DM initializes the AM management information area 172 according to the AM management information acquired from the snapshot 210.

On the other hand, when the AM succeeds in readout of the AM management information from the special LBA area 162 (“Yes” at step S76), the AM does not access the DRAM 11. In this way, the AM read out the AM management information from any one of the special LBA area 162 and the AM management information area 172 of the DRAM 11.

As explained above, concerning the snapshot area 170, when the power supply is turned on, the DM directly expands data from the NAND memory 12 on the DRAM 11 and initializes the data. Therefore, when the AM is started up, it is guaranteed that the AM management information is initialized by backup data.

In the explanation of this embodiment, the AM management information stored in the special LBA area 162 is copied and stored in the AM management information area 172 of the DRAM 11. However, a storage method for the AM management information is not limited to this method. For example, the AM management information area 172 of the DRAM 11 can be used as a write cache in storing the AM management information in the special LBA area 162 to map the AM management information to the AM management information area 172. In other words, the AM management information can be stored in the AM management information area 172 once and then stored in the special LBA area 162.

In the explanation of this embodiment, the management information area 171 is provided in the snapshot 210 and the management information such as the cache management information 41 is also stored as the snapshot 210. However, information stored in the snapshot 210 can be only the AM management information.

The information stored as the snapshot 210 is not limited to the management information such as the cache management information 41, the AM management information, and the like. Other information can be stored as the snapshot 210.

As explained above, according to this embodiment, the AM management information is stored in the special LBA area 162 and also stored in the normal LBA area 160 of the NAND memory 12 as the snapshot 210. Therefore, it is possible to improve reliability of restoration of the AM management information in performing the initialization processing for the memory system 10.

The charge accumulating layer is not limited to the floating gate type and can be a charge trap type including a silicon nitride film such as the Metal-Oxide-Nitride-Oxide-Semiconductor (MONOS) structure and other systems.

The present invention is not limited to the embodiments described above. Accordingly, various modifications can be made without departing from the scope of the present invention.

Furthermore, the embodiments described above include various constituents with inventive step. That is, various modifications of the present invention can be made by distributing or integrating any arbitrary disclosed constituents.

For example, various modifications of the present invention can be made by omitting any arbitrary constituents from among all constituents disclosed in the embodiments as long as problem to be solved by the invention can be resolved and advantages to be attained by the invention can be attained.

Furthermore, it is explained in the above embodiments that a cluster size multiplied by a positive integer equal to or larger than two equals to a logical page size. However, the present invention is not to be thus limited.

For example, the cluster size can be the same as the logical page size, or can be the size obtained by multiplying the logical page size by a positive integer equal to or larger than two by combining a plurality of logical pages.

Moreover, the cluster size can be the same as a unit of management for a file system of OS (Operating System) that runs on the host apparatus 1 such as a personal computer.

Furthermore, it is explained in the above embodiments that a track size multiplied by a positive integer equal to or larger than two equals to a logical block size. However, the present invention is not to be thus limited.

For example, the trick size can be the same as the logical block size, or can be the size obtained by multiplying the logical block size by a positive integer equal to or larger than two by combining a plurality of logical blocks.

If the track size is equal to or larger than the logical block size, MS compaction processing is not necessary. Therefore, the TFS 11b can be omitted.

### Second Embodiment

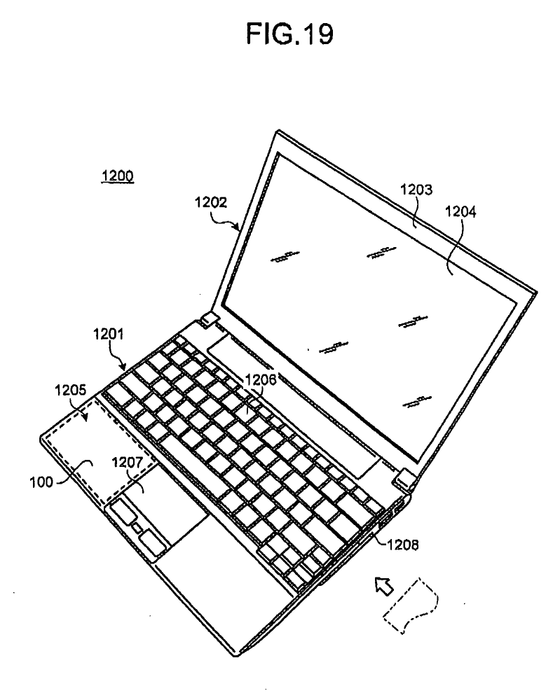

FIG. 19 shows a perspective view of an example of a personal computer. A personal computer 1200 includes a main body 1201 and a display unit 1202. The display unit 1202 includes a display housing 1203 and a display device 1204 accommodated in the display housing 1203.

The main body 1201 includes a chassis 1205, a keyboard 1206, and a touch pad 1207 as a pointing device. The chassis 1205 includes a main circuit board, an ODD unit (Optical Disk Device), a card slot, and the SSD 1100 described in the first embodiment.

The card slot is provided so as to be adjacent to the peripheral wall of the chassis 1205. The peripheral wall has an opening 1208 facing the card slot. A user can insert and remove an additional device into and from the card slot from outside the chassis 1205 through the opening 1208.

The SSD 1100 may be used instead of the prior art HDD in the state of being mounted in the personal computer 1200 or may be used as an additional device in the state of being inserted into the card slot of the personal computer 1200.

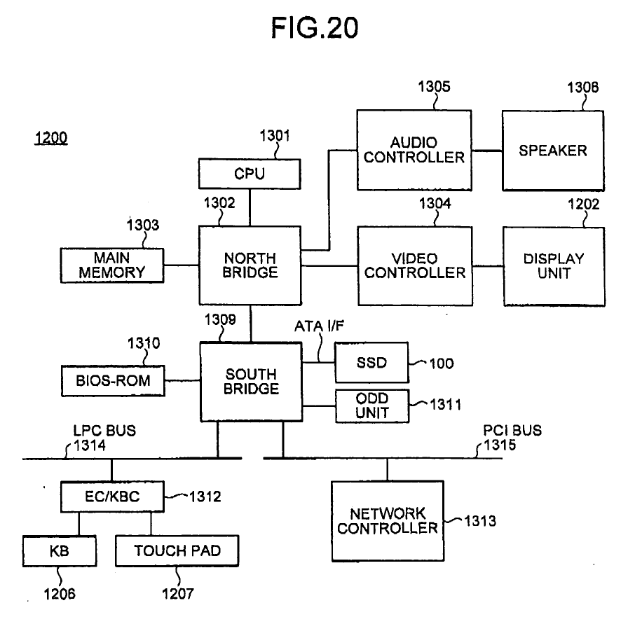

FIG. 20 shows a diagram of an example of system architecture in a personal computer. The personal computer 1200 is comprised of CPU 1301, a north bridge 1302, a main memory 1303, a video controller 1304, an audio controller 1305, a south bridge 1309, a BIOS-ROM 1310, the SSD 1100 described in the first embodiment, an ODD unit 1311, an embedded controller/keyboard controller (EC/KBC) IC 1312, and a network controller 1313.

The CPU 1301 is a processor for controlling an operation of the personal computer 1200, and executes an operating system (OS) loaded from the SSD 1100 to the main memory 1303. The CPU 1301 executes these processes, when the ODD unit 1311 executes one of reading process and writing process to an optical disk. The CPU 1301 executes a system BIOS (Basic Input Output System) stored in the BIOS-ROM 1310. The system BIOS is a program for controlling a hard ware of the personal computer 1200.

The north bridge 1302 is a bridge device which connects the local bus of the CPU 1301 to the south bridge 1309. The north bridge 1302 has a memory controller for controlling an access to the main memory 1303. The north bridge 1302 has a function which executes a communication between the video controller 1304 and the audio controller 1305 through the AGP (Accelerated Graphics Port) bus.

The main memory 1303 stores program or data temporary, and functions as a work area of the CPU 1301. The main memory 1303 is comprised of, for example, DRAM. The video controller 1304 is a video reproduce controller for controlling a display unit which is used for a display monitor (LCD) 1316 of the portable computer 1200. The Audio controller 1305 is an audio reproduce controller for controlling a speaker of the portable computer 1200.

The south bridge 1309 controls devices connected to the LPC (Low Pin Count) bus, and controls devices connected to the PCI (Peripheral Component Interconnect) bus. The south bridge 1309 controls the SSD 1100 which is a memory device stored soft ware and data, through the ATA interface.

The personal computer 1200 executes an access to the SSD 1100 in the sector unit. For example, the write command, the read command, and the cache flash command are input through the ATA interface. The south bridge 1309 has a function which controls the BIOS-ROM 1310 and the ODD unit 1311.

The EC/KBC 1312 is one chip microcomputer which is integrated on the embedded controller for controlling power supply, and the key board controller for controlling the key board (KB) 1206 and the touch pad 1207. The EC/KBC 1312 has a function which sets on/off of the power supply of the personal computer 1200 based on the operation of the power button by user. The network controller 1313 is, for example, a communication device which executes the communication to the network, for example, the internet.

Although the memory system in the above embodiments is comprised as an SSD, it can be comprised as, for example, a memory card typified by an SD card. Moreover, the memory system can be applied not only to a personal computer but also to various electronic devices such as a cellular phone, a PDA (Personal Digital Assistant), a digital still camera, a digital video camera, and a television set.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory system comprising:
a first storing area included in a volatile semiconductor memory from which data is read out and to which data is written;
a second storing area included in a nonvolatile semiconductor memory from which data is read out and to which data is written; and
a controller that performs data transfer between a host apparatus and the second storing area via the first storing area, writes internal information concerning an operation state of the memory system in a special LBA area allocated to a predetermined logical address range in the second storing area and writes the internal information in the first storing area, and reads out, when the memory system is started up, the internal information written in the special LBA area to manage the operation state, wherein
the controller stores the internal information written in the first storing area in the second storing area as a snapshot when a predetermined condition is satisfied, captures, when the memory system is started up, the internal information stored in the second storing area as the snapshot into the first storing area, and reads out the internal information captured into the first storing area when an error occurs and the internal information written in the special LBA area cannot be read out when the memory system is started up.

2. The memory system according to claim 1, wherein
the snapshot has management information including a storage position of data written in the first or second storing area, and
the controller stores the management information and the internal information in the second storing area as the snapshot and captures, when the memory system is started up, the management information and the internal information stored in the second storing area as the snapshot into the first storing area.

3. The memory system according to claim 1, wherein the controller stores the internal information written in the special LBA area in the second storing area such that the internal information is handled in a management system same as that for the snapshot in the second storing area.

4. The memory system according to claim 1, wherein the controller writes at least one of statistical information, a warning event history, and time information in the memory system in the special LBA area and the first storing area as the internal information.

5. The memory system according to claim 1, wherein the controller writes SMART information in the special LBA area and the first storing area as the internal information.

6. The memory system according to claim 2, wherein the controller writes, when an update amount of the management information or the internal information exceeds a predetermined amount, the update management information or internal information in the special LBA area and the first storing area.

7. The memory system according to claim 5, wherein the controller writes the management information or the internal information in the special LBA area and the first storing area at timing corresponding to importance of the management information or the internal information.

8. The memory system according to claim 1, wherein the controller copies, after storing the snapshot in the special LBA area, the snapshot stored in the special LBA area and writes the snapshot in the first storing area.

9. The memory system according to claim 1, wherein the controller uses, as a write cache in storing the snapshot in the special LBA area, an area of the first storing area in which the snapshot is written.

10. The memory system according to claim 1, wherein the special LBA area is an area accessed by a command issued by a module configuring firmware expanded in the memory system.

11. The memory system according to claim 1, wherein the special LBA area is an area, access to which from the host apparatus is prohibited.

12. A memory system comprising:
a first storing area included in a volatile semiconductor memory from which data is read out and to which data is written;
a second storing area included in a nonvolatile semiconductor memory from which data is read out and to which data is written; and
a data managing unit that manages an operation state of the memory system, wherein
the data managing unit includes:
a data transfer unit that performs data transfer between a host apparatus and the second storing area via the first storing area;
a management-information managing unit that writes internal information concerning an operation state of the memory system in a special LBA area allocated to a predetermined logical address range in the second storing area and writes the internal information in the first storing area, and stores, when a predetermined condition is satisfied, the internal information written in the first storing area in the second storing area as a snapshot; and
a management-information restoring unit that reads out, when the memory system is started up, the internal information written in the special LBA area and captures the internal information stored in the second storing area as the snapshot into the first storing area, and reads out the internal information captured into the first storing area when an error occurs and the internal information written in the special LBA area cannot be read out when the memory system is started up.

13. The memory system according to claim 12, wherein
the snapshot has management information including a storage position of data written in the first or second storing area,
a management-information managing unit stores the management information and the internal information in the second storing area as the snapshot, and
a management-information restoring unit captures, when the memory system is started up, the management information and the internal information stored in the second storing area as the snapshot into the first storing area.

14. The memory system according to claim 12, wherein the management-information managing unit stores the internal information written in the special LBA area in the second storing area such that the internal information is handled in a management system same as that for the snapshot in the second storing unit.

15. The memory system according to claim 12, wherein the management-information managing unit writes at least one of statistical information, a warning event history, and time information in the memory system in the special LBA area and the first storing area as the internal information.

16. The memory system according to claim 12, wherein the management-information managing unit writes SMART information in the special LBA area and the first storing area as the internal information.

17. The memory system according to claim 13, wherein the management-information managing unit writes, when an update amount of the management information or the internal information exceeds a predetermined amount, the update management information or internal information in the special LBA area and the first storing area.

18. The memory system according to claim 17, wherein the management-information managing unit writes the management information or the internal information in the special LBA area and the first storing area at timing corresponding to importance of the management information or the internal information.

19. A memory initializing method comprising:
performing, using a first storing area included in a volatile semiconductor memory from which data is read out and to which data is written and a second storing area included in a nonvolatile semiconductor memory from which data is read out and to which data is written, data transfer between a host apparatus and the second storing area via the first storing area;
writing internal information concerning an operation state of the memory system in a special LBA area allocated to a predetermined logical address range in the second storing area and writing the internal information in the first storing area;
storing the internal information written in the first storing area in the second storing area as a snapshot when a predetermined condition is satisfied;
capturing, when the memory system is started up, the internal information stored in the second storing area as the snapshot into the first storing area; and
reading out the internal information captured into the first storing area when an error occurs and the internal information written in the special LBA area cannot be read out when the memory system is started up.

20. The memory initializing method according to claim 19, wherein
the snapshot has management information including a storage position of data written in the first or second storing area, and
the memory initializing method further includes storing, when the predetermined condition is satisfied, the management information and the internal information in the second storing area as the snapshot and capturing, when the memory system is started up, the management information and the internal information stored in the second storing area as the snapshot into the first storing area.
